(19) United States
(12) Patent Application Publication
(10) Pub. No.: US 2012/0261284 A1
(43) Pub. Date: Oct. 18, 2012

(54) Clean Bag Deploying Trash Receptacle

(76) Inventor: Erin Thurmond, Far Rockaway, NY (US)

(21) Appl. No.: 13/221,891

(22) Filed: Aug. 30, 2011

Related U.S. Application Data
(60) Provisional application No. 61/378,236, filed on Aug. 30, 2010.

(51) Int. Cl. B65F 1/14; B65F 1/06

(52) U.S. Cl. 206/223

(57) ABSTRACT

A trash receptacle lining system utilizes a roll or box of perforated or adhered plastic trash bags stored in a self cleaning bag compartment. The free end of the trash bag is received through the slotted partition into the upper portion of the receptacle. This allows a new trash bag liner to be conveniently installed upon removal of a filled trash bag. The slotted opening is raised to reduce waste fluid contamination of the trash bags and has bristles mounted thereon to remove any solids from the outside of the trash bags.

### CROSS-REFERENCE TO RELATED APPLICATIONS

This application claims the benefit of U.S. Provisional Patent Application No. 61/378,236 filed Aug. 30, 2010, the disclosure of which is hereby incorporated by reference in its entirety.

### FIELD OF THE INVENTION

The present invention relates to trash receptacle or trash can which self deploys a new clean bag when the previous bag is removed. More particularly it pertains to an improved trash receptacle system which utilizes a roll or box of trash bags separated by perforated tear zones or glued with a releasable adhesive.

### BACKGROUND OF THE INVENTION

Utilizing conventional trash receptacles, an individual must remove a filled trash bag and subsequently manually install a new bag within the receptacle. This forces the individual to bend over and to have manual contact with the frequently soiled interior of the trash receptacle. In order to overcome this problem, the present invention provides a trash receptacle lining system in which a new trash bag is automatically moved into an operative position upon removal of a filled bag, while keeping the new bag as clean as possible during deployment.

Various types of trash receptacle lining systems are known in the prior art. A typical example of such a lining system is to be found in U.S. Pat. No. 3,451,453, which issued to E. Heck on Jun. 24, 1969. This patent discloses a waste receptacle having an inserted trash bag dispenser. U.S. Pat. No. 3,701,522, which issued to T. Chi on Oct. 31, 1972, discloses a method of folding sheet material for serial extraction from dispensers. U.S. Pat. No. 4,319,694, which issued to J. Nehrbass et al on Mar. 16, 1982, discloses a trash receptacle having open top and bottom ends separated by a transverse partition and including a concave transverse well adapted to receive a roll of trash bag liners. U.S. Pat. No. 4,349,123, which issued to Y. Yang on Sep. 14, 1982, discloses a trash receptacle utilizing an inserted trash bag dispenser. U.S. Pat. No. 4,721,226, which issued to E. Yurko on Jan. 26, 1988, discloses a trash receptacle having a lateral insertion slot for a trash bag dispensing box. U.S. Pat. No. 4,955,505 describes a trash container having a receptacle to hold trash bags on a roller which may be drawn up.

A frequent problem of prior designs is that, should a bag rip during use, the spilled contents will pool or fall onto the roll or box of bags stored at the bottom. This results in filthy bags being continuously deployed into the interior of the trash receptacle, and subsequently being placed outside or in collection rooms. This creates an unacceptable and unsanitary condition, especially in large buildings and facilities where many full bags are stored on loading docks or trash rooms prior to pick up.

While the above mentioned devices are directed to trash receptacle systems, none of these devices describe a trash receptacle having features which ensure that the trash bag outer surface is kept as clean as possible. Nor do they have easy load features, such as a tray, slot or door opening on an exposed side of the trash can for loading fresh boxes or rolls of bags.

Lastly, none of the above patented designs are known to be manufactured currently, due to the aforementioned bag exterior surface cleanliness problem and the cost of manufacturing trash cans with a variety of stationary and moving parts, as well as the need for proprietary bags (e.g. those located on a roll). What is needed is an improved trash receptacle which addresses the aforementioned cleanliness issues, having a minimum of moving parts and thus being easy to manufacture and allowing for maintenance personnel to rapidly empty and re-bag the trash receptacle.

### SUMMARY OF THE INVENTION

According to exemplary embodiments of the present invention, which will be described subsequently in greater detail, a trash receptacle provides for the automatic deployment of clean trash bags as the old full bag is removed from the container and regulates the flow of fluids from ruptured bags.

According to an exemplary embodiment of the present invention, the trash receptacle can be any standard type trash can, into the bottom of which is fitted a slotted housing, creating a bag compartment in which trash bags are stored. The bag compartment can have a door opening located on the side of the trash receptacle to reload bags or boxed or rolled bags. The trash receptacle's height can be adjusted to account for the space consumed by the bag compartment, so as to allow maximal space for the deployed trash bag to hang.

Automatic deployment of a bag is effected by connecting each bag contained in the bag compartment to the next bag. Bags may be connected to each other by perforations or preferably by a low tack adhesive which is easy to remove. As a bag is removed from the trash receptacle, it automatically draws up a replacement bag, and the operator then detaches the replacement bag from the bag being removed. The replacement bag may then be opened and seated onto the rim of the container. Optionally, bags may be fitted with a drawstring, or elastic band, allowing for more rapid seating.

According to another exemplary embodiment of the present invention, the slotted housing has raised edges, such that fluids falling onto the slotted housing from, for example, ruptured bags or rainwater, are diverted away from the slotted opening in the housing. This diversion keeps trash bags in the bag compartment relatively free of fluids such as liquid contaminants and moisture.

In yet another exemplary embodiment, fluids are diverted to the sides where they can be collected in a drip pan or allowed to dry on the bottom of the trash receptacle.

According to yet another exemplary embodiment of the present invention, the slotted housing has one or more brushes, and preferably a pair of brushes positioned along the long edges of the slot. These brushes serve to clear debris from the exterior of trash bags as they are deployed upwards when a bag in use is removed from the trash receptacle. Such brushes are preferably made of stiff polyester or other suitable bristle material. Optionally, the brushes are removable from the slotted housing for cleaning or replacement.

These together with other embodiments of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

FIG. 1 is a perspective view of a trash receptacle lining system according to embodiments of the present invention.

FIG. 2 is an exploded view illustrating components of a bag compartment according embodiments of the present invention.

### DESCRIPTION OF THE INVENTION

With reference now to the drawings, embodiments of a new and improved bag lining system of the present invention are now described with reference to a trash bag lining system. However, it is to be understood that embodiments of the present invention are not limited to waste bags and may be utilized to deploy any type of bag onto a container, for example laundry bags or packing bags for various loose goods (e.g. styrofoam peanuts, grains, flours, cements, or other bulk commodities commonly packed in bags).

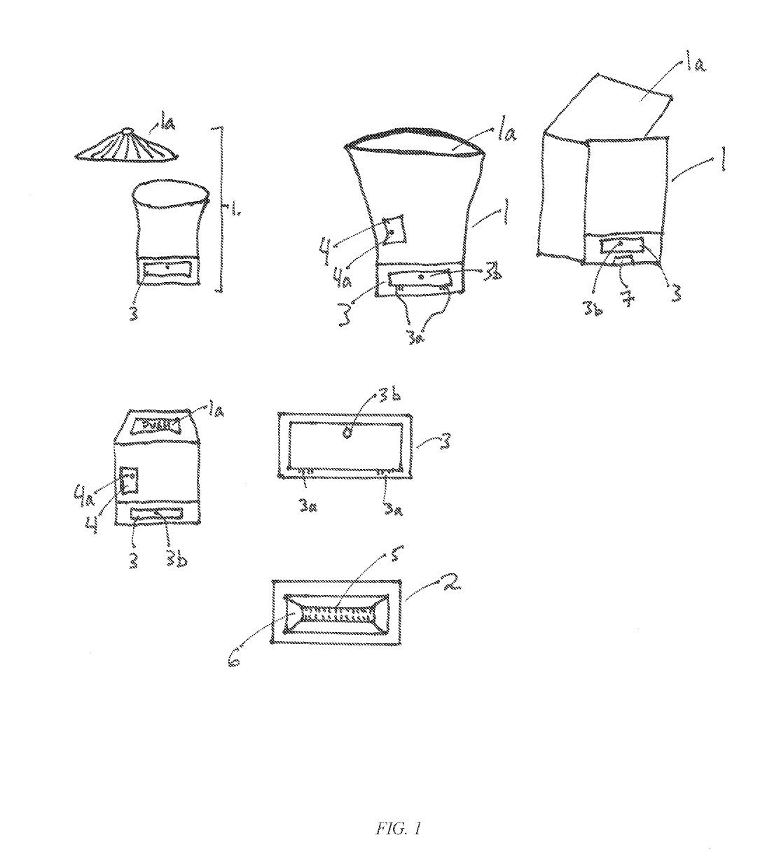

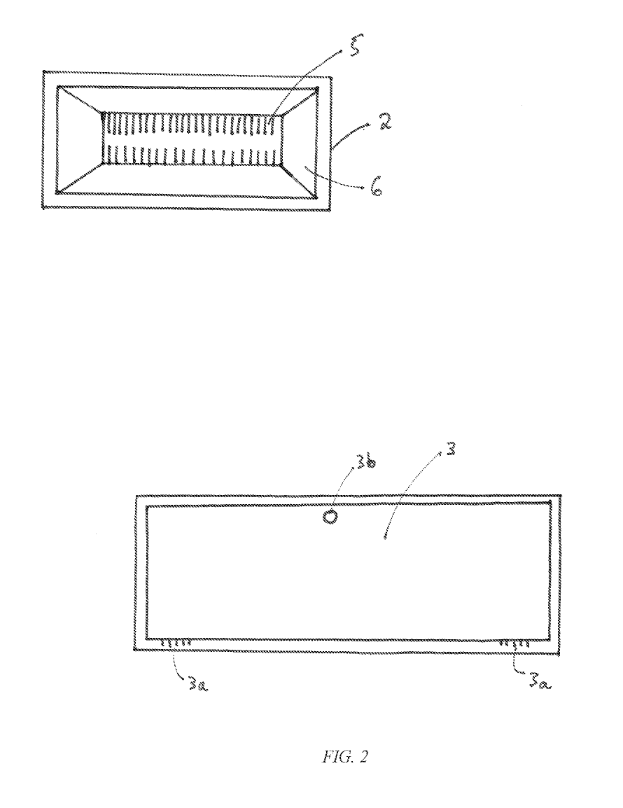

Referring now to FIGS. 1 and 2, a trash receptacle 1, according to exemplary embodiments of the present invention, is provided which can be of any general shape commonly used for trash receptacles (e.g. a substantially cylindrical shape, can or rectangular box) and can have any form of commonly used cover or lid, including a removable lid, a hinged lid, a hinged and latched lid, or a swinging lid.

According to exemplary embodiments of the present invention, trash receptacle 1, can be made out of materials typically used for trash receptacles, for example metals, plastics, wood or some combination thereof or any other suitable material. Preferably, the trash receptacle is formed from molded plastic(s) such as polyethylenes, polyvinyls, or polypropylenes. More preferably, the trash receptacle can be formed from recycled plastics, metals, wood or other recycled materials.

Trash receptacle 1, according to exemplary embodiments of the present invention, is comprised of a slotted housing 2, a bag compartment opening 3, an optional access door 4 and an optional drip pan 7.

According to exemplary embodiments of the present invention, slotted housing 2 is mounted above the bottom of the trash receptacle to form a bag compartment. The slotted housing 2 is comprised of a bristled slotted opening 5 which preferably opens at the highest point of a raised cover 6. The bristled slotted opening 5 serves to clean trash bags as they are deployed from the bag compartment formed by the slotted housing. Bristled slotted opening 5 can be formed from a rectangular mount which contains bristles which may be or natural or synthetic fibers. Bristled slotted opening 5 can be fashioned such that it is removable from the slotted housing 2 for cleaning or replacement or it can be non-removable. Alternatively, bristled slotted opening 5 can be formed from the edges of slotted housing 2 itself, which can be punctured to accommodate bristles.

According to exemplary embodiments of the present invention, raised cover 6 can be formed in the shape of a raised rectangular diamond, with four faces inclined upwards and meeting at the middle to form the opening in slotted housing 2. Slotted housing 2 can be mounted to the edges of trash receptacle 1 such that there is a gap along the joint, allowing for fluid waste to pass down the side and to the bottom of trash receptacle 1. The bag compartment can be fitted with clips or raised edges to hold the trash bag box or roll above the bottom of the trash receptacle 1 or above the drip pan 7.

In exemplary embodiments of the present invention, a bag compartment opening 3 is provided in the side of trash receptacle 1 so as to facilitate the loading of boxed or rolled trash bags into the bag compartment. Bag compartment opening 3 can be a cut opening, or can be an opening fitted with a door. Exemplary doors include a self-closing spring door having springs 3a, or sliding door each of which can be fitted with a handle or knob 3b.

Preferably, trash bags which are physically attached to each other by glue or perforations are loaded into the bag compartment, such that when a full bag is removed from trash receptacle 1 a new bag is automatically pulled up. More preferably, trash bags are attached to each other by a low tack adhesive which is easy to remove.

According to another exemplary embodiment of the present invention, an optional access door 4 is provided in the side of trash receptacle 1, so as to allow access to trash bags in the event a bag is lost during deployment of anew bag onto the lip of the trash receptacle 1. In this manner a user can simply access the bag compartment and pull up a new bag which can be passed up to the lip lip of the trash receptacle 1.

In yet another exemplary embodiment of the present invention, an optional drip pan 7 is provided which can slide out from the bottom of trash receptacle 1. Drip pan 7 is situated to collect fluid waste which can drip from broken bags onto the raised cover 6 and drip down the gap along the joint between the slotted housing 2 and walls of trash receptacle 1, allowing for fluid waste to pass down the side of trash receptacle 1 and to the bottom of trash receptacle 1. Further, the bag compartment can be fitted with clips or raised edges to keep the trash bag box or roll above the bottom of the trash receptacle 1 or above the drip pan 7.

Referring now to FIG. 3, in yet another embodiment a detachable bottom bag receptacle is provided which serves to store trash bags and can be utilized as a detachable wheeled dolly for trash cans. In this embodiment the trash can has an orifice in its bottom portion through which bags pass from the bag receptacle. Preferably this orifice is covered with a material which is water repellent and which has a slit or cross slit or other opening through which bags pass.

As will now be understood, the present invention provides a trash receptacle lining system which may be originally formed as an integral part of a trash receptacle, or adapted for installation into existing conventional trash receptacles. In either case, the present invention provides a trash receptacle lining system which allows individuals to rapidly and conveniently install a trash bag liner into a trash receptacle without bending over or coming into manual contact with a potentially contaminated trash receptacle, while self cleaning bags as they are deployed.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

It is to be understood that the aforementioned embodiments of the present invention are not limited to waste bags and may be utilized to deploy any type of bag onto a container, for example laundry bags, packing bags for various loose goods (e.g. styrofoam peanuts, grains, flours, cements or other bulk commodities commonly packed in bags).

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A receptacle, comprising:
a receptacle having an intermediate transverse partition forming a bag compartment;
a slot formed through said partition;
wherein the slot has one or more brushes to sweep the outer surface of a bag as it is deployed.

2. The receptacle of claim 1 wherein the intermediate transverse partition has an inclined surface.

3. The receptacle of claim 1 wherein the intermediate transverse partition has gaps between itself and the receptacle.

4. The receptacle of claim 3 wherein the receptacle is fitted with a drip pan.

5. The receptacle of claim 1 wherein the bag compartment has an opening.

6. The receptacle of claim 5 wherein the opening is a door.

7. The receptacle of claim 6 wherein the door is self closing.

8. The receptacle of claim 1 wherein the brushes are mounted onto a removable housing.

9. A receptacle, comprising:
a receptacle having an intermediate transverse partition forming a bag compartment;
a slot formed through said partition;
wherein the intermediate transverse partition is inclined.
